(19) United States
(12) Patent Application Publication
(10) Pub. No.: US 2026/0324850 A1
(43) Pub. Date: Oct. 22, 2026

(54) CLEANER

(71) Applicant: Patrick Jeremy RICE, New South Wales (AU)

(72) Inventor: Patrick Jeremy RICE, New South Wales (AU)

(21) Appl. No.: 19/726,659

(22) Filed: Jun. 30, 2026

Related U.S. Application Data
(63) Continuation of application No. 16/915,570, filed on Jun. 29, 2020, now abandoned.
Application No. 16/915,570 is a continuation of application No. 15/711,912, filed on Sep. 21, 2017, now abandoned.
Application No. 15/711,912 is a continuation of application No. 14/813,050, filed on Jul. 29, 2015, now abandoned.
Application No. 14/813,050 is a continuation of application No. 14/498,947, filed on Sep. 26, 2014, now abandoned.
Application No. 14/498,947 is a continuation of application No. 13/138,172, filed on Jan. 15, 2010, now abandoned.

(30) Foreign Application Priority Data
Jan. 16, 2009 (AU) 2009900182

(51) Int. Cl. A46B 17/06; A46B 11/06; B44D 3/00

(52) U.S. Cl. CPC A46B 17/06; A46B 11/063; B44D 3/006; A46B 2200/202

(57) ABSTRACT

A cleaning apparatus; said apparatus combining mechanical combing action and liquid flow to remove detritus from frond-like structures.

### BACKGROUND OF THE INVENTION

The present invention relates to the cleaning of items by controlled application of a stream of fluid and, more particularly, but not exclusively to the cleaning of paintbrushes and like items which have a strand-like structure.

The cleaning of items or structures made from strands or fronds can be difficult.

For example the cleaning of paintbrushes after use is both a time consuming and inefficient process. Although various liquid and mechanical cleaning systems have been devised, in the case of the latter these may be complicated, relatively expensive, themselves difficult to clean and generally unsatisfactory.

It is an object of the present invention to address or at least ameliorate some of the above disadvantages or at least provide a useful alternative.

### Notes

1. The term “comprising” (and grammatical variations thereof) is used in this specification in the inclusive sense of “having” or “including”, and not in the exclusive sense of “consisting only of”.

2. The above discussion of the prior art in the Background of the invention, is not an admission that any information discussed therein is citable prior art or part of the common general knowledge of persons skilled in the art in any country.

### BRIEF DESCRIPTION OF THE INVENTION

### Definitions

In this specification the term “frond like structure” is to be taken to refer to a structure which incorporates strands or filaments usually in a substantially parallel alignment. Specific but not limiting examples of such structures include the bristles in a paintbrush or the aligned hair in a horse's tail.

Accordingly, in one broad form of the invention there is provided cleaning apparatus; said apparatus combining mechanical combing action and liquid flow to substantially remove detritus from structures incorporating frond-like structures.

Preferably said frond like structures comprise the bristles of a paintbrush.

Preferably said mechanical combing action is provided by a multi-tyned comb structure; tynes of said multi-tyned comb structure adapted for intrusion into, and longitudinal movement through or between bundles of said frond like structures.

Preferably said liquid flow issues from at least one liquid flow orifice adjacent an outer end of each tyne of said multi-tyned comb structure.

Preferably said at least one orifice is arranged so as to direct said liquid flow substantially parallel to each tyne of said multi-tyned comb structure.

Preferably said liquid flow is arranged in a fine, narrow fan-shaped jet issuing from said orifice.

Preferably said liquid is water.

Preferably said tynes of said multi-tyned comb structure extend from a manifold body portion of said apparatus.

Preferably said manifold body portion extends from a handle portion shaped for grasping by the hand of a user.

Preferably each of said tynes of said multi-tyned structure is formed with hard edges so as to act as scrapers as said tyne moves between bristles of a said paintbrush.

Preferably said manifold portion of said structure is formed with hard edges which act as scrapers as said tynes move through said frond like structure.

Preferably said handle portion is provided with a connector spigot at one end of said handle portion; said connector spigot adapted for connection to socket outlet fitting of a water supply hose.

Preferably said handle portion, said manifold body portion, said tynes of said multi-tyneed structure and said connector spigot, form an integral unitary structure.

Preferably said integral unitary structure is formed by a blow moulding process.

In a further broad form of the invention there is provided a method of substantially removing residual paint from the bristles of a paintbrush; said method including the steps of;
(a) connecting a paintbrush cleaning apparatus to a water supply hose,
(b) pushing tynes of a multi-tyneed structure of said paintbrush cleaning apparatus between bristle bundles of said paintbrush,
(c) repeatedly moving said tynes from an initial location adjacent the head of said paintbrush to the end of said bristle bundles, and wherein fan-shaped jets of water issuing from an orifice located between said tynes act to dislodge said residual paint from said bristles.

Preferably steps (a) to (c) are repeated for each side of said paintbrush.

Preferably said fan-shaped jets of water issue from one side of each of said tynes; said jets issuing substantially normal to said multi-tyneed structure.

Preferably said apparatus is moved along a side of said paintbrush in such a manner that said fan-shaped jets of water urge said residual paint towards the ends of said bristles.

Thus in yet a further broad form of the invention there is provided a method of substantially removing residue from a frond like structure; said method including the steps of;
A) connecting a cleaning apparatus to a water supply,
B) pushing tynes of a multi-tyned structure of said cleaning apparatus between or through the fronds of said frond like structure wherein fan-shaped jets of water issuing from an orifice located between said tynes act to dislodge said residue.

### BRIEF DESCRIPTION OF THE DRAWINGS

Embodiments of the present invention will now be described with reference to the accompanying drawings wherein:

FIG. 1 is a perspective view of a cleaning apparatus according to a preferred embodiment of the invention,

FIG. 2 is a further perspective view of the apparatus of FIG. 1 showing a preferred spray pattern,

FIG. 3 is a perspective view of the apparatus of FIGS. 1 and 2 when applied to a paintbrush in use,

FIG. 4 is a perspective view of a cleaner according to a second preferred embodiment, and

FIG. 5 is a side view of the cleaner of FIG. 4.

### DETAILED DESCRIPTION OF PREFERRED EMBODIMENTS

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the example embodiments described herein can be made without departing from the spirit and scope of the present disclosure.

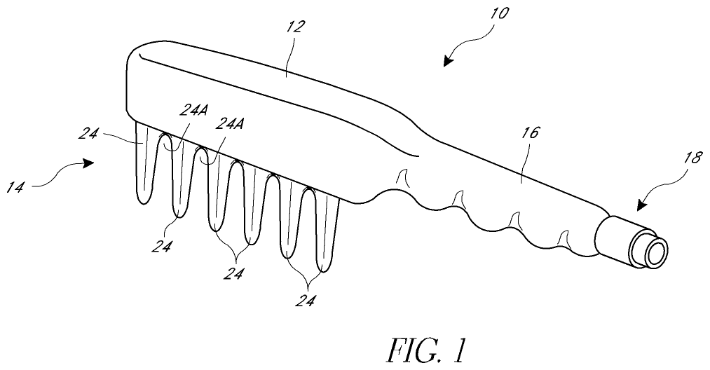

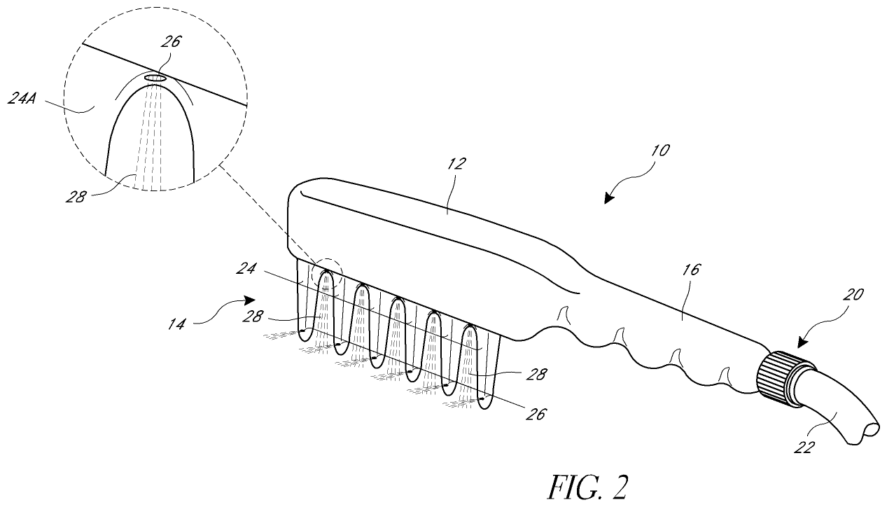

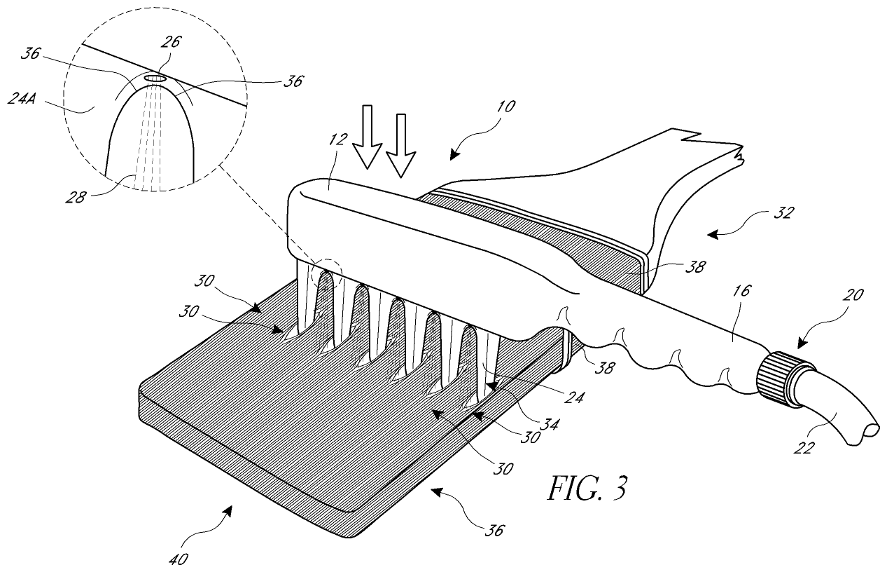

With reference to FIGS. 1 to 3, in a first preferred embodiment of the invention, a cleaning apparatus 10 includes a manifold body portion 12 from which extends a multi-tyne comb structure 14. Apparatus 10 further includes a handle portion 16 extending from manifold body portion 12, and a spigot 18 to which may be connected a connection socket 20 of a water supply hose 22, as can be seen in FIGS. 2 and 3.

Preferably, manifold body portion 12, the comb structure 14, handle portion 16 and spigot 18 form a unitary integral whole, and are hollow. Thus the inside of each tyne 24 is in fluid communication with manifold body portion 12 which in turn is in fluid communication with the handle portion 14 and spigot 18. Preferably, the apparatus 10 is blow moulded from a suitable polymer.

In a preferred form the tynes 24 are arranged so as to be substantially parallel to each other and spaced apart from each other as illustrated with arcuate grooves 24A defined therebetween.

Each arcuate groove 24A is provided with an orifice 26 as shown in the inset of FIG. 2. Preferably, each orifice 26 is so formed as to create a fan-shaped jet 28 of water when water is caused to enter the apparatus 10 under pressure. Preferably, the jet 28 issues between the tynes 24 and substantially parallel to the comb structure 14.

Each tyne 24 of comb structure 14, is adapted for intrusion into the fronds of a frond like structure such as bundles of bristles 30 of a paintbrush 32 as can be seen in FIG. 3. The leading edges 34 of the tynes may be hard or sharp edges, so formed to act as scrapers against the bristles 36 of the paintbrush 32 during longitudinal movement of the apparatus relative to the bristles of the paintbrush.

### In Use

As soon as practicable after use of a paintbrush 32, the apparatus 10 of a preferred embodiment of the invention is connected to a water supply hose 22 and, while holding the paintbrush 32 over a suitable waste water receptacle (not shown), the tynes 24 of the apparatus and the water jets 28 issuing from between the tynes, are insinuated between the bristles 36 from a first side of the paintbrush. In a preferred form insertion can be as close as possible to the head, or ferule 38 of the paintbrush with the water jets 28 directed towards the outer ends 40 of the bristles 36. The apparatus 10 is then moved towards the ends 40 of the bristles, dragging the tynes 24 of the comb structure 14 through the bristles. The water jets 28 then urge paint residue dislodged by the force of the jets 28 and the scraping action of the edges 34 of the tynes 24, towards and off the ends of the bristles.

As can be seen in the inset of FIG. 3 the bristles 36 become compacted against the arcuate structure 24A in the region where the water jet first emerges from orifice 26 from where the water then flows along the path of least resistance between the tynes and away from body portion 12.

This action may be repeated a number of times before applying the same procedure to the other side of the paintbrush. The whole process of application to one side and then the other of the paintbrush, may be repeated a number of times until the residual paint is substantially removed from the bristles.

### Second Embodiment

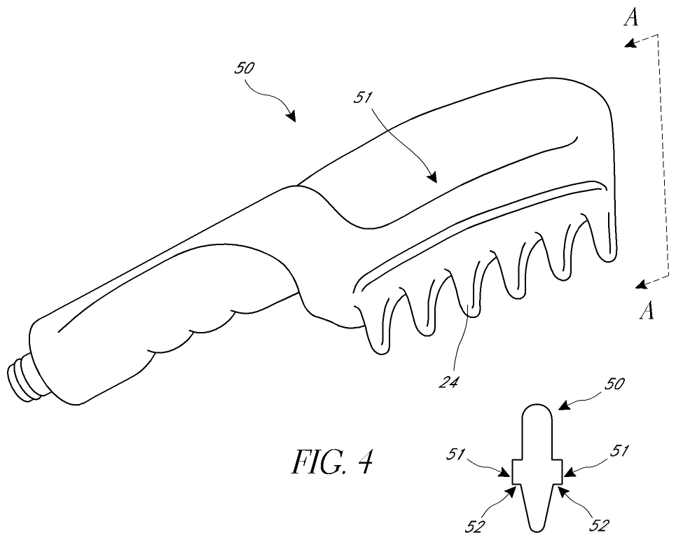

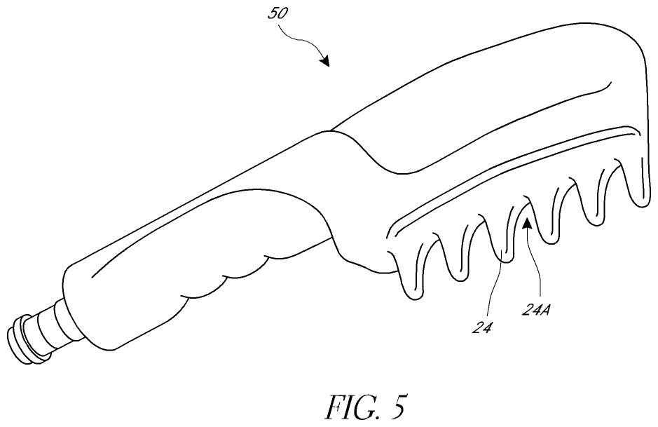

With reference to FIGS. 4 and 5 there is illustrated a cleaner 50 in accordance with a second preferred embodiment of the present invention. The structure is substantially the same as that for the first embodiment and like components are numbered accordingly. As can be seen in front view inset AA of FIG. 4 a ridge structure 51 is defined on each side of the line of tynes. This ridge structure 51 includes a hard edge 52 which acts to scrape against the bristles of the paintbrush so as to remove hardened paint or like detritus.

The above describes only some embodiments of the present invention and modifications, obvious to those skilled in the art, can be made thereto without departing from the scope of the present invention. Thus, for example, although the above description has focused on the use of water, it will be understood that with a suitable pressurised source, other liquids such as detergents, thinners and other cleaning agents may be passed through the apparatus and otherwise in accordance with the method of the invention.

Also, the handle portion 16 may receive alternative connections to it so as to allow, for example, connection to different kinds of hoses or connection to other accessories such as a soap dispenser.

1-19. (canceled)

20. A cleaning apparatus combining mechanical combing action and liquid flow to substantially remove detritus from structures incorporating frond-like structures, said cleaning apparatus comprising: an elongated manifold body portion; and a multi-tyned comb structure integrally formed with the elongated manifold body portion to form an integral unitary structure, the multi-tyned comb structure extending along the length of the elongated manifold body portion and comprising: tynes, each tyne having a base integral with the manifold body portion and an outer end, each tyne extends away from the elongated manifold body portion; arcuate grooves, wherein an arcuate groove is positioned between the bases of each pair of adjacent tynes; and orifices, wherein: each arcuate groove includes one of the orifices; each orifice in an arcuate groove is formed to create a fan-shaped jet of water when water enters the cleaning apparatus under pressure; and one of the orifices is positioned adjacent the outer end of each tyne, the orifice adjacent the outer end of each tyne being the only orifice in the tyne and being positioned to face away from the multi-tyned comb structure in a direction normal to the multi-tyned comb structure.

21. The cleaning apparatus of claim 20 wherein the orifice positioned adjacent the outer end of each tyne directs the liquid flow substantially normal to the multi-tyned comb structure.

22. The cleaning apparatus of claim 20 wherein the elongated manifold body portion is integrally formed with and extends from a handle portion, wherein the handle portion is shaped for grasping by the hand of a user.

23. The cleaning apparatus of claim 20 wherein each of the tynes is formed with hard edges to act as scrapers as the tyne moves between bristles of a paintbrush.

24. The cleaning apparatus of claim 20 wherein the manifold body portion is formed with hard edges which act as scrapers as said tynes move through the frond-like structure.

25. The cleaning apparatus of claim 22 wherein the handle portion is provided with a connector spigot at one end of the handle portion, the connector spigot being adapted for connection to a socket outlet fitting of a water supply hose.

26. The cleaning apparatus of claim 25 wherein the handle portion and the connector spigot are included in the integral unitary structure.

27. The cleaning apparatus of claim 26 wherein the integral unitary structure is formed by a blow molding process.

28. A method of substantially removing residual paint from bristles of a paintbrush, said method comprising the steps of: A) connecting a paintbrush cleaning apparatus to a water supply hose, the paintbrush cleaning apparatus including an elongated manifold body portion integrally formed with a multi-tyned comb structure to form an integral unitary structure, the multi-tyned comb structure extending along the length of the elongated manifold body portion and comprising: tynes, each tyne having a base integral with the multi-tyned comb structure and an outer end, each tyne extends away from the paintbrush cleaning apparatus;
arcuate grooves, wherein an arcuate groove is positioned between the bases of each pair of adjacent tynes; and
orifices, wherein:
each arcuate groove includes one of the orificesi; each orifice in an arcuate groove is formed to create a fan-shaped jet of water when water enters the cleaning apparatus under pressure; and
one of the orifices is positioned adjacent the outer end of each tyne, the orifice adjacent the outer end of each tyne being the only orifice in the tyne and being positioned to face away from the multi-tyned comb structure in a direction normal to the multi-tyned comb structure;
B) pushing the tynes between bristle bundles of the paintbrush; and
C) repeatedly moving the tynes from an initial location adjacent a head of the paintbrush to an end of the bristle bundles, wherein fan-shaped jets of water issuing from the orifices act to dislodge the residual paint from the bristle bundles, and the tynes have hard or sharp leading edges acting to scrape against bristles of the paintbrush.

29. The method of claim 28 wherein steps (A) to (C) are repeated for each side of the paintbrush.

30. The method of claim 28 wherein the fan-shaped jets of water issue from one side of each tyne, and the jets issue substantially normal to the multi-tyned comb structure.

31. The method of claim 28 wherein the apparatus is moved along a side of the paintbrush in such a manner that the fan-shaped jets of water urge the residual paint towards the ends of the bristles.

32. A method of substantially removing residue from a frond-like structure comprising the steps of: A) connecting a cleaning apparatus to a water supply, the cleaning apparatus including an elongated manifold body portion integrally formed with a multi-tyned comb structure to form an integral unitary structure, the multi-tyned comb structure extending along the length of the elongated manifold body portion and comprising: tynes, each tyne having a base integral with the multi-tyned comb structure and extending away from the cleaning apparatus; arcuate grooves, wherein an arcuate groove is positioned between the bases of each pair of adjacent tynes; and orifices, wherein: each arcuate groove includes one of the orifices; each orifice in an arcuate groove is formed to create a fan-shaped jet of water when water enters the cleaning apparatus under pressure; and one of the orifices is positioned adjacent the outer end of each tyne, the orifice adjacent the outer end of each tyne being the only orifice in the tyne and being positioned to face away from the multi-tyned comb structure in a direction normal to the multi-tyned comb structure; and
B) pushing the tynes between or through fronds of the frond-like structure, wherein fan-shaped jets of water issuing from the orifices act to dislodge the residue.

33. The cleaning apparatus of claim 20 wherein: the elongated manifold body portion includes a top, a side and a bottom; the multi-tyned comb structure is integrally formed with the elongated manifold body portion on the bottom of the elongated manifold body portion; and the orifice adjacent the outer end of each tyne is positioned to face away from the elongated manifold body portion in a direction normal to the side of the elongated manifold body portion.
